(19) United States
(12) Patent Application Publication
(10) Pub. No.: US 2015/0120578 A1
(43) Pub. Date: Apr. 30, 2015

(54) SYSTEM AND METHOD FOR DIAGNOSING MACHINE FAULTS

(71) Applicant: General Electric Company, Schenectady, NY (US)

(72) Inventors: NICHOLAS EDWARD RODDY, SCHENECTADY, NY (US); DUSTIN ROSS GARVEY, SAN RAMON, CA (US); RUI XU, REXFORD, NY (US)

(73) Assignee: General Electric Company, Schenectady, NY (US)

(21) Appl. No.: 14/269,676

(22) Filed: May 5, 2014

Related U.S. Application Data
(63) Continuation-in-part of application No. 14/067,179, filed on Oct. 30, 2013.

(51) Int. Cl. G06Q 10/00

(52) U.S. Cl. CPC G06Q 10/20
USPC 705/305

(57) ABSTRACT

A system and method are provided that can identify instructive fault identifiers to assist in the diagnosis of machine faults. The system and method can obtain fault identifiers indicative of potential faults of machines. Frequencies of occurrences of the fault identifiers among the reference cases and determining coverage indices of the fault identifiers can be determined. The coverage indices may indicate how many of the reference cases associated with a selected repair recommendation include one or more of the fault identifiers. The system and method also can determine confusion probabilities that the fault identifiers are indicative of a repair recommendation other than the selected repair recommendation and identify at least one of the fault identifiers as instructive fault identifiers for the selected repair recommendation based on the frequencies of occurrences, the coverage indices, and/or the one or more confusion probabilities.

### CROSS-REFERENCE TO RELATED APPLICATIONS

This application is a continuation-in-part of U.S. patent application Ser. No. 14/067,179, which was filed on 30 Oct. 2013, and is titled “System And Method For Diagnosing Machine Faults,” the entire disclosure of which is incorporated by reference.

### BACKGROUND

The subject matter disclosed herein generally relates to analyzing a fault log of a machine. More specifically, the subject matter described herein relates to methods and systems for a diagnosis and/or repair of the machine based on data associated with the operation of the machine.

Case Based Reasoning (CBR) includes a technique of problem solving based on rules and behaviors learned from experiential knowledge (memory of past experiences or cases). CBR focuses on indexing, retrieval, reuse, and archival of cases. CBR is used generally for diagnosis and repair of systems related to healthcare, transportation, and other infrastructure related systems.

CBR has been employed in equipment monitoring and remote diagnostics, call center automation, and in productivity tools. Quality management initiatives involving obtaining measurement data, analyzing the data, making improvements based on the data, and maintaining the improvement by continuously collecting data suits adoption of CBR techniques.

One known problem with some systems that employ CBR is a high nuisance firing rate that can occur when the system is converted between different machines, such as from a legacy machine to a newer machine. The data previously used to diagnose faults in the legacy machine may not be as useful for examining operating data of the newer machine and, as a result, more incorrect or missed diagnoses of faults can occur.

### BRIEF DESCRIPTION

In one embodiment, a method of identifying instructive fault identifiers to assist in the diagnosis of machine faults includes obtaining potentially instructive fault identifiers indicative of potential faults of one or more machines. The potentially instructive fault identifiers can be compared to reference fault identifiers included in different reference cases that are associated with repair recommendations for the one or more machines. The method also can include determining frequencies of occurrences of the potentially instructive fault identifiers among the reference cases and determining coverage indices of the potentially instructive fault identifiers. The coverage indices indicate how many of the reference cases associated with a selected repair recommendation of the repair recommendations include one or more of the potentially instructive fault identifiers. The method also can include determining one or more confusion probabilities that the one or more of the potentially instructive fault identifiers is indicative of a repair recommendation other than the selected repair recommendation and identifying at least one of the potentially instructive fault identifiers as instructive fault identifiers for the selected repair recommendation based on one or more of the frequencies of occurrences, the coverage indices, and/or the one or more confusion probabilities.

In another embodiment, a system (e.g., a fault identifier system) includes a training module configured to obtain potentially instructive fault identifiers indicative of potential faults of one or more machines. The potentially instructive fault identifiers can be compared to reference fault identifiers included in different reference cases that are associated with repair recommendations for the one or more machines. The training module also can be configured to determine frequencies of occurrences of the potentially instructive fault identifiers among the reference cases and to determine coverage indices of the potentially instructive fault identifiers. The coverage indices can indicate how many of the reference cases associated with a selected repair recommendation of the repair recommendations include one or more of the potentially instructive fault identifiers. The training module also can be configured to determine one or more confusion probabilities that the one or more of the potentially instructive fault identifiers is indicative of a repair recommendation other than the selected repair recommendation and to identify at least one of the potentially instructive fault identifiers as instructive fault identifiers for the selected repair recommendation based on one or more of the frequencies of occurrences, the coverage indices, or the one or more confusion probabilities.

In another embodiment, another method (e.g., for diagnosing machine faults) includes examining fault identifiers associated with different reference cases associated with different repair recommendations for one or more machines. The fault identifiers are representative of potential faults of the one or more machines, and can be examined to differentiate instructive fault identifiers from nuisance fault identifiers. The method also can include identifying actual fault identifiers determined from sensory data obtained from an operating machine and determining one or more repair recommendations for the operating machine by comparing the actual fault identifiers with the instructive fault identifiers.

### DRAWINGS

These and other features and aspects of embodiments of the subject matter described herein will become better understood when the following detailed description is read with reference to the accompanying drawings in which like characters represent like parts throughout the drawings, wherein:

FIG. 1 is a diagrammatic illustration of a system for diagnosis of an operating condition of a machine in accordance with an embodiment;

FIG. 2 is a schematic illustration of a case having a plurality of structural features derived from data obtained from a machine in accordance with an embodiment;

FIG. 3 is an illustration of a table having a plurality of reference cases, structural features associated with each case, and a fault identifier associated with each reference case in accordance with an embodiment;

FIG. 4 is a schematic flow diagram illustrating generation of a plurality of reference structural features, and fault identifiers from a case identification number in accordance with an embodiment;

FIG. 5 is a schematic flow diagram illustrating identification of nuisance structural features from a plurality of reference structural features in accordance with an embodiment;

FIG. 6 is a schematic flow diagram illustrating identification of a first subset of instructive structural features in accordance with an embodiment;

FIG. 7 is a table for computation of a statistical significance parameter in accordance with an embodiment;

FIG. 8 is a schematic flow diagram illustrating generation of a plurality of fault identifiers in accordance with an embodiment;

FIG. 9 is a flow chart illustrating steps involved in identification of at least one fault identifier from a sensory data obtained from an operating machine in accordance with an embodiment; and

FIGS. 10A and 10B include a flow chart illustrating a method of identifying instructive fault identifiers according to an embodiment of the subject matter described herein.

### DETAILED DESCRIPTION

Embodiments of the present disclosure relate to a system and a method for performing at least one of a diagnosis of a condition of operation and a repair of a diagnosed condition of a malfunctioning machine based on measured data associated with the operation of the malfunctioning machine. Specifically, in certain embodiments, a plurality of measured structural features is obtained from sensory data of a machine. A plurality of reference cases corresponding to the sensory data are obtained from a database. The plurality of reference cases includes a plurality of reference structural features and a plurality of fault identifiers. A statistical parameter is computed based on the plurality of reference cases. A first subset of reference structural features from the plurality of reference structural features is obtained based on the computed statistical parameter. A plurality of similarity values are computed based on the obtained first subset of reference structural features and the plurality of measured structural features. At least one fault identifier among the plurality of fault identifiers is identified based on the computed plurality of similarity values.

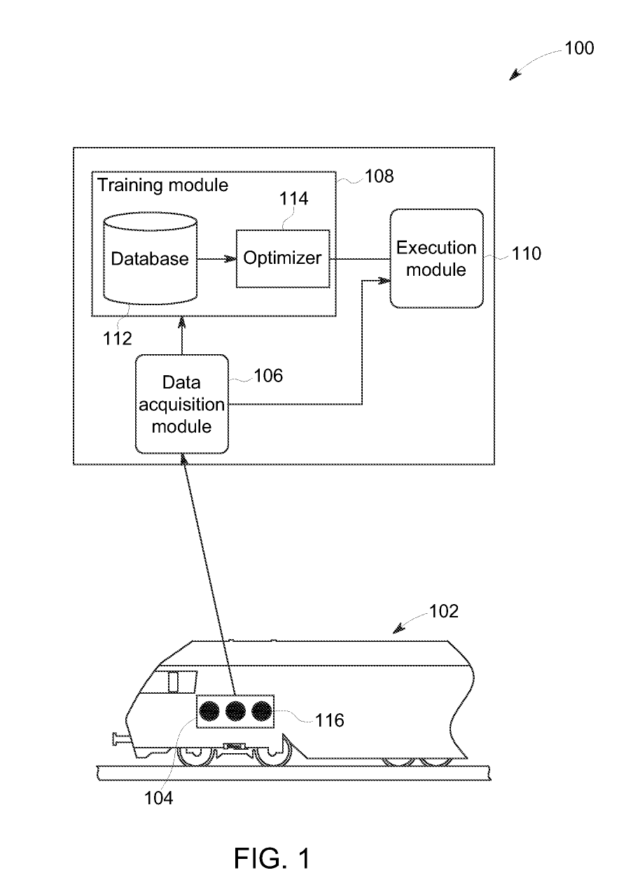

FIG. 1 illustrates a schematic diagram of a fault identifier system 100 used for diagnosis of an operation condition of a machine 102. It should be noted herein that the fault identifier system 100 can include a case based reasoning system. The system 100 includes a sensing unit 104 having a plurality of sensors 116 for generating a sensory data indicative of an operating condition of the machine 102. In the illustrated embodiment, the machine 102 is a locomotive. In another embodiment, the machine 102 may be a medical imaging modality such as a MRI machine, a CT machine, or the like. In another embodiment, the machine 102 may be an aircraft engine or a power generation system. Optionally, the machine 102 may be another type of system. For example, it should be noted herein that the fault identifier system 100 is applicable to other type of machines that require diagnosis of an operating condition. The sensory data includes information that can be used to determine an operating condition of the machine 102. A portion of the sensory data used to identify the operating condition of the machine 102 is referred to herein as a “case”. The case includes a plurality of structural features representative of a plurality of the fault conditions (faults) of the machine 102. The term “structural feature” used herein refers to a fault or a sequence of faults of the machine 102.

A data acquisition module 106 is communicatively coupled to the sensing unit 104. The data acquisition module 106 is configured to receive the sensory data from the sensing unit 104. The data acquisition module 106 may receive sensory data from the sensing unit 104 through a communication link such as a wired, a wireless, or an internet network. In one embodiment, the data acquisition module 106 may be a standalone customized hardware component. In another embodiment, the data acquisition module 106 may be stored in a memory and executable by a processor. The system 100 further includes a training module 108 communicatively coupled to the data acquisition module 106. In the illustrated embodiment, the training module 108 includes a database 112 and an operations module 114. The database 112 may be used to store a plurality of reference cases corresponding to the sensory data. The plurality of reference cases includes a plurality of reference structural features and a plurality of fault identifiers. In one embodiment, the database 112 may be an off-the-shelf database module integrated with the operations module 114. The term “reference case” refers to a previously labeled processed case stored in the database 112. The term ‘fault identifier’ refers to an operating condition of the machine 102 of the machine 102 associated with the reference case. In one aspect, a fault identifier may represent a fault code, such as an alphanumeric or other character string used to identify a fault of the machine 102. As a result, a fault identifier can represent or indicate a potential fault with the machine 102. In one embodiment, the training module 108 may be a standalone customized hardware component. In another embodiment, the training module 108 may be stored in a memory and executable by a processor. In an embodiment where the data acquisition module 106 is disposed on the machine 102, the training module 108 receives the sensory data through a communication link from the data acquisition module 106.

The operations module 114 is communicatively coupled to the database 112 and configured to obtain a first subset of reference structural features from the plurality of reference structural features. The details of obtaining the first subset of reference structural features are explained in greater detail with reference to subsequent figures. In one embodiment, the operations module 114 may be a customized hardware component. In another embodiment, the operations module 114 may be stored in a memory and executable by a processor. For example, the operations module 114 can represent one or more sets of instructions, such as computer software, stored on one or more computer readable storage media, such as a dynamic random access memory (DRAM) device, a static random access memory (SRAM) device, flash memory, a non-volatile memory, a storage device such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, other non-volatile storage devices, or the like. In an alternate embodiment, the operations module 114 may be a sub-module implemented either as hardware component or software component within the training module 108. In certain other embodiments, the operations module 114 may be integrated with the training module 108.

The system 100 also includes an execution module 110 communicatively coupled to the data acquisition module 106 and the operations module 114. The execution module 110 is configured to identify at least one fault identifier among the plurality of fault identifiers, based on the plurality of measured structural features and the first subset of reference structural features. In one embodiment, the execution module 110 may be a customized hardware component. In another embodiment, the execution module 110 may be stored in a memory and executable by a processor.

In one embodiment, at least one module of the data acquisition module 106, the training module 108, and the execution module 110 may be a customized hardware component designed to perform respective specified functionality. In an alternate embodiment, at least one module of the data acquisition module 106, the training module 108, and the execution module 110 may be a software component stored in at least one memory and executed by at least one processor-based unit. In an example embodiment, some modules of the training module 108, the operations module 114, and the execution module 110 are executed by a first processor-based unit. In such an embodiment, the remaining modules of the training module 108, the operations module 114, and the execution module 110 are executed by a second processor-based unit communicatively coupled with the first processor-based unit. Data may be exchanged between the first processor-based unit and the second processor-based unit depending on the configuration of the system.

At least one processor-based unit may include at least one arithmetic logic unit, microprocessor, general purpose controller or other processor arrays to perform computations, and a memory module. The processing capability of at least one processor-based unit, in one embodiment, may be limited to retrieval of data and transmission of data. The processing capability of at least one processor-based unit, in another embodiment, may include performing more complex tasks such as obtaining the measured structural features from the sensory data, obtaining reference structural features from the reference cases, and the like. In other embodiments, other type of processors, operating systems, and physical configurations are also envisioned. The processor-based unit may also include or be communicatively coupled to at least one memory module. The memory module may be a non-transitory storage medium. For example, the memory module may be a dynamic random access memory (DRAM) device, a static random access memory (SRAM) device, flash memory or other memory devices. In one embodiment, the memory module also includes a non-volatile memory or a storage device such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or other non-volatile storage devices. In one embodiment, the non-transitory computer readable medium is encoded with a program to instruct at least one processor-based device to identify fault of the machine 102.

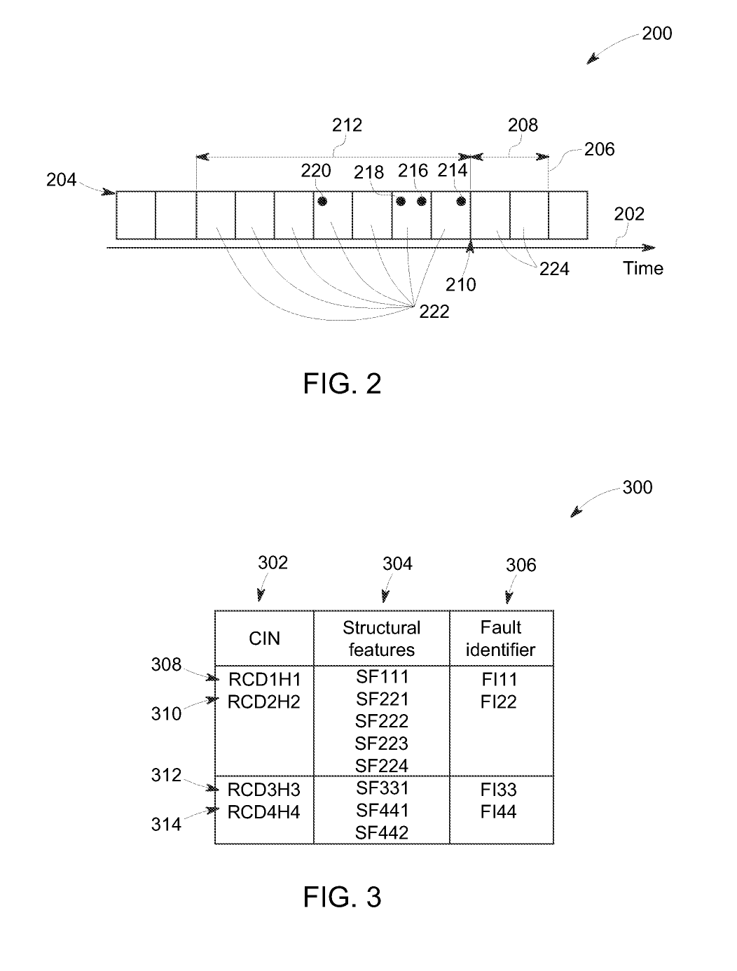

FIG. 2 is schematic representation of a case 200 having a plurality of structural features derived from data generated from a machine in accordance with an example embodiment. The case 200 is illustrated with an x-axis 202 representative of time and a machine data 204 having a plurality of data units 222. The generation of the plurality of data units 222 with reference to time is shown herein. In the illustrated embodiment, each of the data units 222 includes the machine data 204 generated over a period of 24 hours. In other embodiments, each of the data units 222 may have machine data for a different time period (e.g., less than 24 hours or greater than 24 hours). A group of sequentially generated data units 222 representative of an operating condition of the machine is included in the case 200. In the illustrated embodiment, the case 200 begins at a time instance 210 and spans over a fixed duration 212. In the illustrated embodiment, the fixed duration 212 extends over a period of several days, each data unit represents approximately a duration of one day. Optionally, the duration 212 may not be fixed in time and/or may extend over a different time period. The example case 200 is represented by a case identification number 206. It should be noted herein that the terms ‘case identification number’ and ‘CIN’ are used interchangeably. The CIN 206 is generated at a time instance along the x-axis 202, when an operating condition associated with the machine is reported.

In the illustrated embodiment, the case 200 represented by the CIN 206, includes a plurality of structural features 214, 216, 218, 220 generated within the fixed duration 212. A variable duration 208 between the time instance 210 (representative of the start of the case 200) and the CIN 206, includes a plurality of data units 224. It should be noted herein that the duration 208 does not include any of the plurality of structural features in the illustrated example. In the illustrated embodiment, two data units 224 spans over the variable duration 208 extending over two days. The data units 222 spanning over the fixed duration 212 are stored in a data base. The term “structural feature” referred herein refers to a fault condition of the machine. For example, the plurality of structural features 214, 216, 218, 220 may be representative of fault conditions of the machine. In an example embodiment, the structural feature may refer to a sequence of faults. As an example, the faults 216, 218 as a sequence may be treated as one structural feature. In alternative embodiments, the term “structural feature” may include other structures such as an n-tuple or a graph, derived from a plurality of fault conditions.

It should be noted herein that the machine data 204 may also be referred to as “sensory data”. A case including the sensory data may be referred to as a “measured case”. A plurality of structural features in the measured case may be referred to herein as “measured structural features”. The machine data processed, labeled, and stored in a database may be referred to herein as “reference data”. A case including the reference data may be referred to herein as a “reference case”. A plurality of structural features in the reference case may be referred to herein as “reference structural features”. The measured case and the reference case have a same data format as represented by the schematic diagram of FIG. 2. Optionally, different data formats may be used.

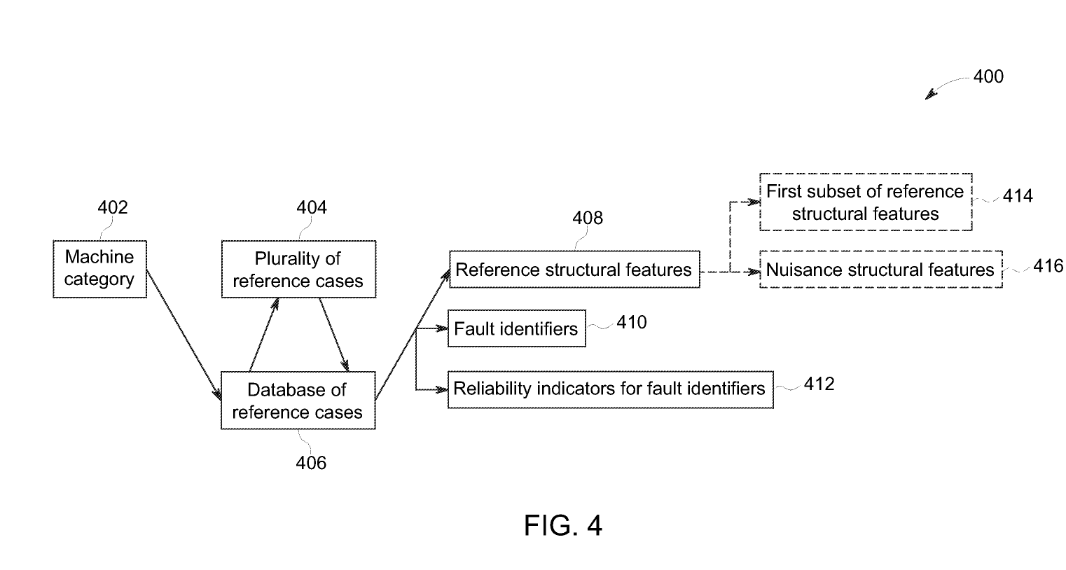

FIG. 3 illustrates a table 300 stored in a database having a plurality of reference cases in accordance with an example embodiment. The table 300 has a first column 302 for storing a CIN, a second column 304 for storing a code of a structural feature, and a third column 306 for storing a fault identifier. In the table 300, a plurality of reference cases 308, 310, 312, 314 are stored. The reference case 308 having a CIN RCD1H1 includes a structural feature SF111 and a fault identifier FI11. The reference case 310 having a CIN RCD2H2, includes four reference structural features SF221, SF222, SF223, and SF224 and a fault identifier FI22. It may be noted herein that a single case may have a plurality of same reference structural features, for example, FI22 in the reference case 310. The reference case 312 having a CIN RCD3H3, includes a reference structural feature SF331 and a fault identifier FI33. The reference case 314 having a CIN RCD4H4, includes two reference structural features SF441 and SF442 and a fault identifier FI44. In certain embodiment, the table 300 may also include another column for providing a reliability indicator for each of the fault identifier. It should be noted herein that the table 300 in this embodiment, is for illustrative purposes only and should not be interpreted as limiting the scope of the inventive subject matter described herein. In an alternative embodiment, the example information may be stored in more than one table. For example, a first table may have columns for storing a CIN and corresponding structural features and a second table may include column for storing fault identifier and corresponding CIN. In some other embodiments, the database may also store additional parameters related to the operation of the machine. Additional parameters may include a category of the machine, date of entry corresponding to the reference case, and other relevant information.

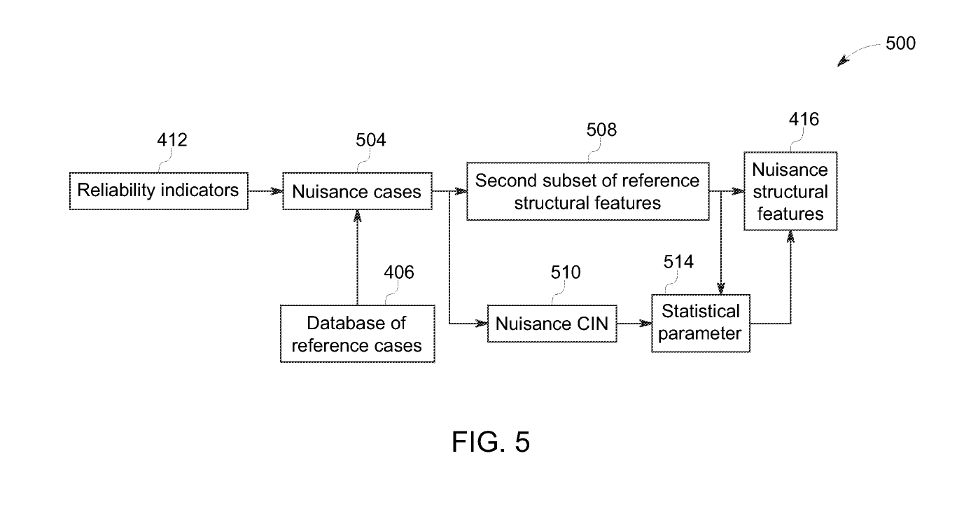

FIG. 4 is a block diagram 400 showing obtaining of a plurality of reference structural features from a database based on the sensory data in accordance with an example embodiment. A category 402 of a machine generating the sensory data is determined based on a CIN. A plurality of reference cases 404 are retrieved from a database 406 based on the category 402 of the machine generating the sensory data. Each reference case has a CIN stored in one or more tables of the database 406. A plurality of reference structural features 408 are retrieved from the database 406 based on the CIN. The plurality of reference structural features 408 includes a first subset 414 of reference structural features and a plurality of nuisance structural features 416. The first subset 414 of reference structural features is determined from the plurality of reference structural features 408. At least one fault identifier is extracted from the database 406 for each CIN and thereby a plurality of fault identifiers 410 is identified. A reliability indicator corresponding to each fault identifier is retrieved from the database 406 and thereby a plurality of reliability indicators 412 is identified. It should be noted herein that for one reference case among the plurality of reference cases 404, a fault identifier may not represent the operating condition of the machine characterized by a plurality of reference structural features associated with the corresponding reference case. Accuracy of the first subset 414 of reference structural features is enhanced by excluding processing of such a reference case. The reliability indicator is a measure of the validity of the corresponding fault identifier in the database for a plurality of reference structural features. For example, a reliability indicator having a higher value is a more accurate indication of the operating condition of the machine characterized by the plurality of reference structural features. The reliability indicator is used to reduce the number of reference structural features from the plurality of reference structural features. The technique of reducing the number of reference structural features is explained in greater detail below.

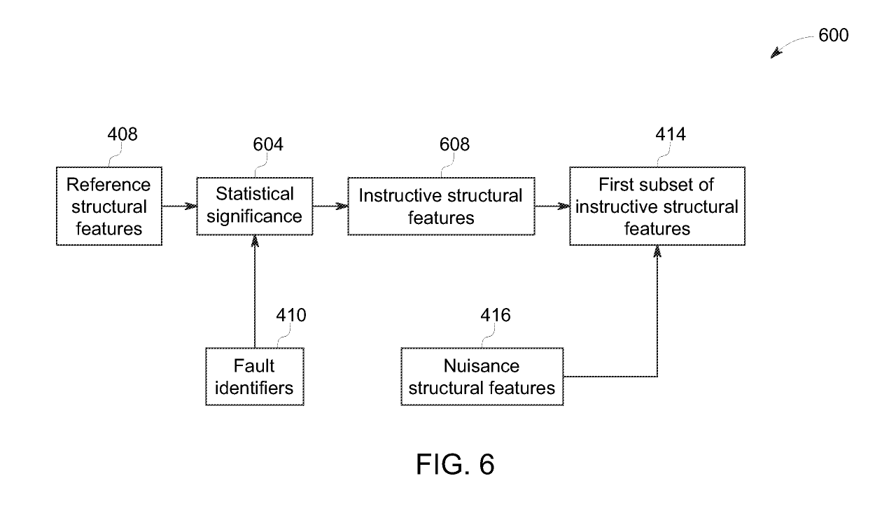

FIG. 5 is a block diagram 500 illustrating identification of a plurality of nuisance structural features from a plurality of reference structural features in accordance with an example embodiment. A plurality of nuisance cases 504 is obtained from the plurality of reference cases stored in the database 406, based on the plurality of reliability indicators 412. A nuisance case is a reference case having an unreliable fault identifier, or that, when examined by the system 100, causes the system 100 to output a repair recommendation that is not appropriate for the fault of the machine 102. In one embodiment, all reference cases having a reliability indicator less than a first threshold value are identified as “nuisance cases”. In one specific embodiment, the first threshold value is a pre-defined threshold value. The pre-defined threshold value may be defined by the user. In an alternate embodiment, the pre-defined threshold value is retrieved from the database based on the category of the machine. A second subset 508 of reference structural features corresponding to the plurality of obtained nuisance cases 504 is identified. In one embodiment, the second subset may include a single reference structural feature listed repeatedly. A plurality of CINs corresponding to the obtained nuisance cases 504 are also identified 510.

The plurality of nuisance structural features 416 is obtained based on the second subset 508 of reference structural features corresponding to the plurality of obtained nuisance cases. A statistical parameter is computed 514 based on the plurality of reference cases. In an example embodiment, the statistical parameter is a frequency parameter used to determine the plurality of nuisance structural features. In such an embodiment, the frequency parameter is assigned to each of the reference structural feature of the second subset. In one embodiment, the frequency parameter is determined based on a number of cases among the plurality of nuisance cases 504, having a reference structural feature. In an alternate embodiment, the number of repetitions of reference structural feature is considered as the frequency parameter. Similarly, a plurality of frequency parameters corresponding to each reference structural feature of the second subset is determined.

A subset of the plurality of frequency parameters greater than a second threshold value is determined. In one embodiment, the second threshold value is defined by a user. In an alternate embodiment, the second threshold value is retrieved from a database. The reference structural features from the second subset of reference structural features, corresponding to the subset of plurality of frequency parameters, are determined as the plurality of nuisance structural features 416.

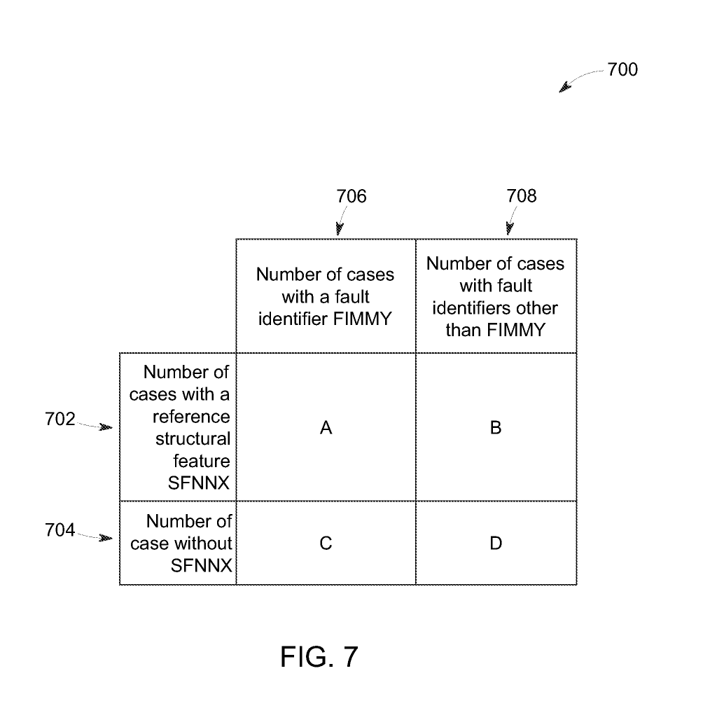

FIG. 6 is a block diagram 600 illustrating identification of an instructive structural feature from the plurality of reference structural features in accordance with an example embodiment. The plurality of reference structural features 408 and the plurality of fault identifiers 410 are used to determine a statistical parameter. In the illustrated embodiment, the statistical parameter is a statistical significance 604 of each reference structural feature with reference to each corresponding fault identifier. In another embodiment, the statistical parameter is a first frequency of occurrence of each reference structural feature with reference to a plurality of reference structural features of the plurality of nuisance cases. The term “statistical significance” used herein refers to a statistical parameter indicative of a probability of incorrectly rejecting one hypothesis instead of another hypothesis. The reference structural feature which is statistically significant is categorized as an “instructive structural feature”. Instructive structural feature is a reference structural feature having useful information for determining an operating condition of the machine. A plurality of instructive structural features is obtained 608 by computing statistical parameter for each reference structural feature. The technique for performing a statistical significance test is explained in greater detail below. The first subset 414 of reference structural features is obtained by selecting the instructive structural features that are not nuisance structural features 416. The first subset 414 of instructive structural features and the measured structural features are used to determine a fault identifier corresponding to the sensory data of the machine.

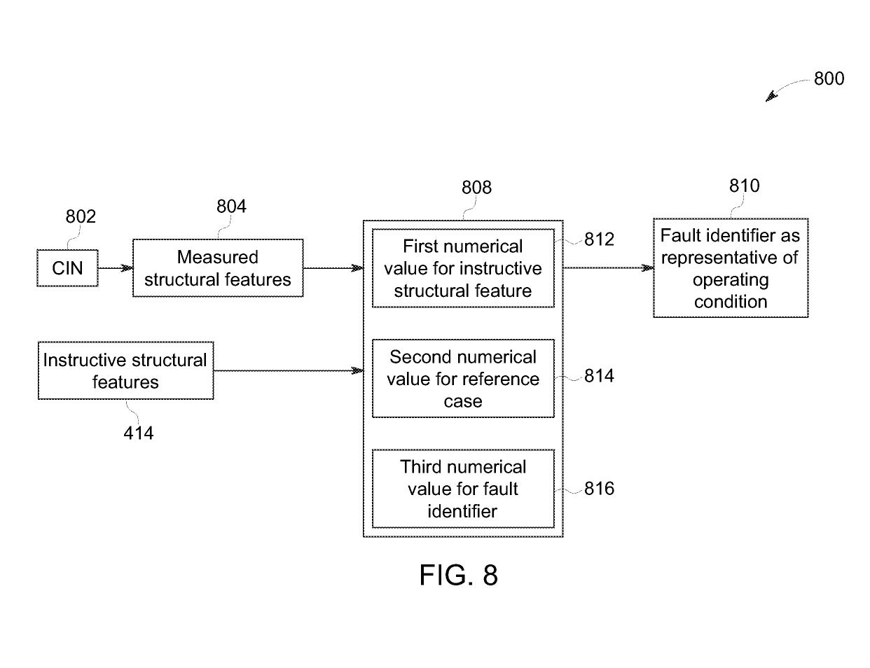

FIG. 7 is a table 700 used to illustrate computation of statistical significance parameter in accordance with an example embodiment. The table 700 is referred herein as a “contingency table” and is constructed with reference to a reference structural feature and a fault identifier. In the illustrated example embodiment, a reference structural feature SFNNX and the fault identifier FIMMY are considered. The table 700 has two rows 702, 704, and two columns 706, 708. The first row 702 is indicative of the number of cases having the reference structural feature SFNNX. The second row 704 is indicative of the number of cases which do not have the reference structural feature SFNNX. The first column 706 is indicative of the number of cases having the fault identifier FIMMY. The second column 708 is indicative of the number of cases which do not have the fault identifier FIMMY. The first row 702 has an entry A representative of the number of cases having the reference structural feature SFNNX and the fault identifier FIMMY corresponding to the first column 706. The first row 702 has another entry B representative of the number of cases that do not have the reference structural feature SFNNX and have the fault identifiers other than FIMMY corresponding to the second column 708. The second row 704 has an entry C indicative of the number of cases that do not have the reference structural feature SFNNX and have the fault identifier FIMMY corresponding to the first column 706. The second row 704 has another entry D representative of the number of cases that do not have the reference structural feature SFNNX and have the fault identifiers other than FIMMY corresponding to the second column 708.

A statistical significance parameter is determined based on the contingency table of FIG. 7. The statistical significance parameter, represented as p, is given by:

$$p = \frac{( A + B ) ! ( C + D ) ! ( A + C ) ! ( A + D ) !}{A ! B ! C ! D ! ( A + B + C + D ) !} \qquad ( 1 )$$

where, A, B, C, and D are entries of the contingency table 700 and the exclamation mark (!) is representative of factorial mathematical operation. If the statistical significance parameter is less than a pre-defined constant value, the reference structural feature SFNNX is determined as “instructive” with reference to the considered fault identifier FIMMY. In a specific example, the value of A is thirty seven, the value of B is twenty one, the value of C is four, the value of D is six hundred and thirty five and the pre-defined constant value is 0.05. In such an example, the statistical significance parameter p is equal to 6.8×10-42. Since the value of p is smaller than 0.05, the reference structural feature SFNNX is instructive with reference to the fault identifier FIMMY.

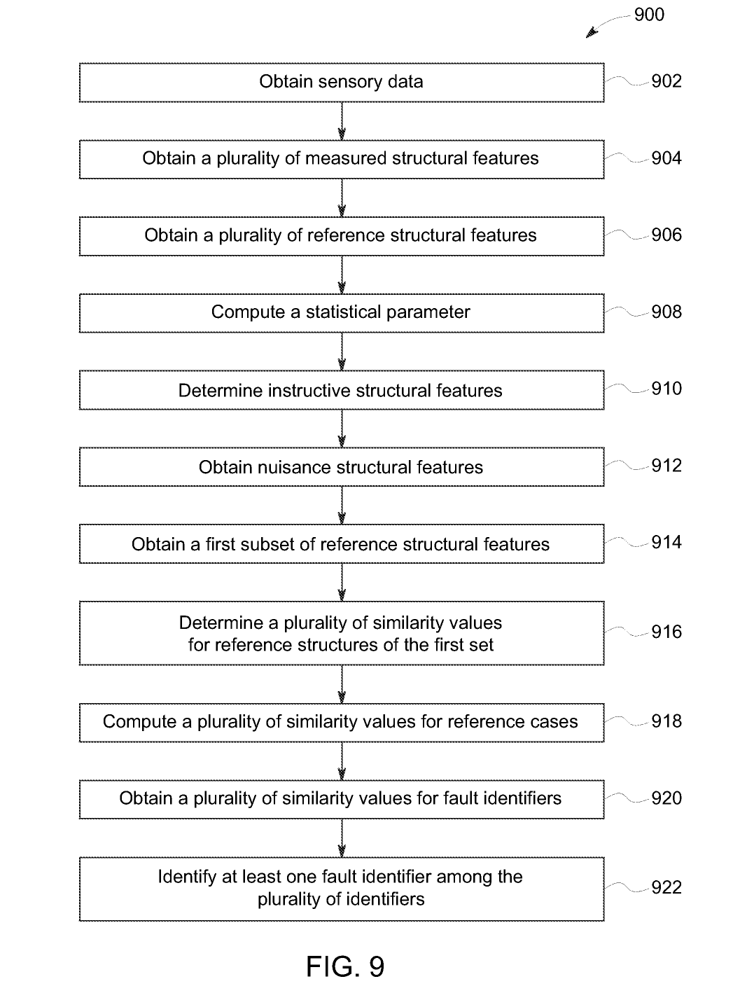

FIG. 8 is a block diagram 800 illustrating generation of at least one fault identifier for sensory data of a machine in accordance with an example embodiment. A CIN 802 corresponding to the sensory data is used to determine measured structural features 804 as explained previously. Similarly, the first subset 414 of reference structural features having a plurality of instructive structural features corresponding to the CIN is obtained as explained previously. A plurality of similarity values are computed 808 based on the first subset 414 of instructive structural features and the measured structural features.

The plurality of similarity values includes a first numerical value 812 of each reference structural feature from the first subset of reference structural features based on a second frequency of occurrence of each reference structural feature with reference to the plurality of measured structural features. In an example embodiment, a structural feature which occurs commonly in the measured structural features and the first subset 414 of reference structural features corresponding to a reference case is considered. The second frequency of occurrence corresponding to the common structural feature is referred to as a ratio of repetition of the common structural feature in the reference case to the repetition of the common structural feature in the measured case. As an example, if CSFID1 is a common structural feature and if CSFID1 is repeated twice in the reference case and four times in the measured case, then the second frequency of occurrence is equal to 0.5. As another example, if CSFID1 occurs once in the reference case and the measured case, then the second frequency of occurrence is equal to one. The second frequency of occurrence may be suitably weighted to determine the first numerical value 812. The first numerical value 812 is represented by:

first_numerical_value=(1−α)+α×second_frequency (2)

where, α is a weighting factor of the second frequency of occurrence. In one example, the value of a is selected as 0.3. In another example, the value of a may be equal to 0.4. It should be noted herein that the equation (2) should not to be construed as a limitation of the invention and the first numerical value 812 may be determined using other similar mathematical formulae indicative of the relative similarity between the measured case and the reference case with reference to the common structural feature.

Further, the plurality of similarity values includes a second numerical value 814 of each reference case determined based on the first numerical value 812 of each reference structural feature. In one embodiment, the plurality of similarity values corresponding to the instructive structural features of the reference case are added together to determine the second numerical value 814 corresponding to the reference case. It should be noted herein that the second numerical value 814 indicative of a similarity value of each reference case with reference to the measured case. The technique of determining a plurality of similarity values corresponding to each reference case is explained in greater detail below.

Further, the plurality of similarity values includes a third numerical value 816 of each fault identifier determined based on the second numerical value 814 of each reference case. In an example embodiment, the third numerical value 816 for a fault identifier is determined by adding a plurality of second numerical values corresponding to a plurality of reference cases having the fault identifier. Further, a plurality of third numerical values corresponding to each of the plurality of fault identifiers is determined. A value among the plurality of third numerical values is then determined (e.g., a maximum value or value that is larger than one or more other values, but is not necessarily the maximum value is determined), and a fault identifier corresponding to the determined value is identified. The fault identifier 810 is representative of the operating condition of the machine. In an alternate embodiment, a subset of values among the plurality of third values is identified. A plurality of fault identifiers corresponding to the subset of identified values is determined.

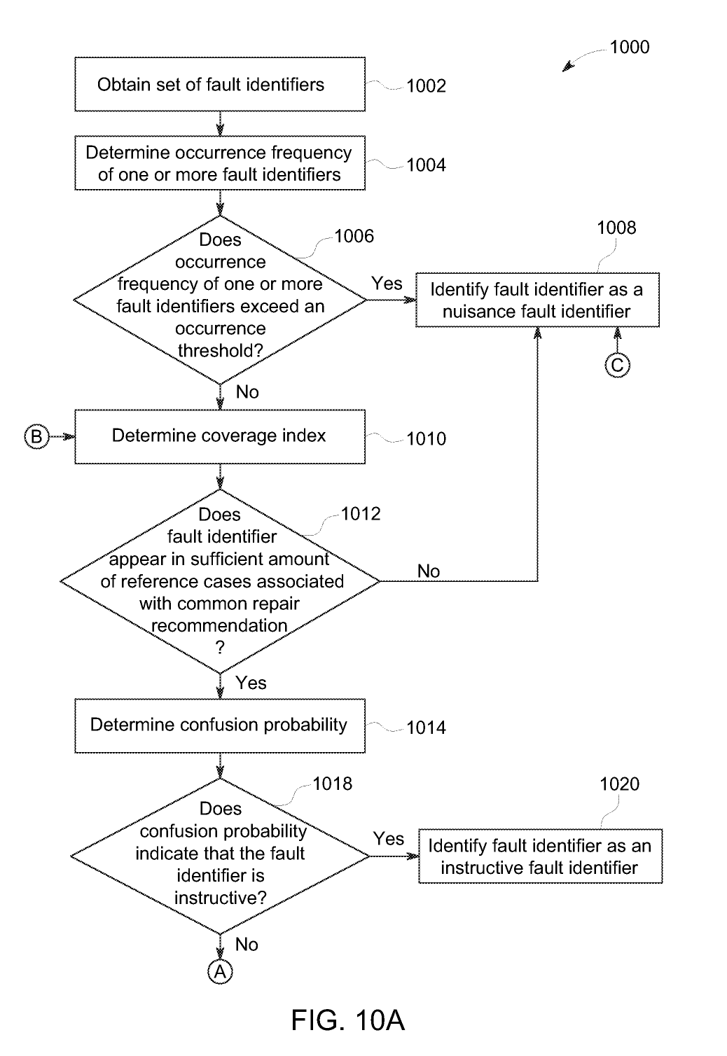

FIG. 9 is a flow chart 900 illustrating a method of identifying at least one fault identifier from a sensory data of an operating machine in accordance with an example embodiment. The sensory data is obtained 902 from the machine and a plurality of measured structural features is obtained 904 based on the obtained sensory data. Each measured structural feature includes at least one of a fault and a sequence of faults. A plurality of reference cases are obtained from a database based on a category of the machine which generates the sensory data. Each reference case has one or more reference structural features. A plurality of reference structural features is obtained 906 from the database, corresponding to the plurality of reference cases. Each reference structural feature also includes a fault and a sequence of faults. The database also includes a plurality of fault identifiers corresponding to each reference case. The database further includes a reliability indicator for each fault identifier. The database may be updated with additional reference cases and corresponding reference structural features when the sensory data is analyzed and new operating conditions are determined.

A statistical parameter is computed 908 based on the plurality of reference cases and the plurality of reference structural features. In one embodiment, a plurality of statistical parameters is computed. In one such embodiment, a first parameter from the plurality of statistical parameters is used to determine an instructive structural feature. In one specific embodiment, the first parameter is a statistical significance of each reference structural feature with reference to each corresponding fault identifier. In such a manner, a plurality of instructive structural features is determined 910 from the plurality of reference structural features. In another embodiment, a second parameter from the plurality of statistical parameters is used to determine a nuisance structural feature. In one such embodiment, the second parameter is a first frequency of occurrence of each reference structural feature with reference to a plurality of reference structural features of the plurality of nuisance cases. In such a manner, a plurality of nuisance structural features is determined 912 from the reference structural features.

A first subset of reference structural features is obtained 914 based on the instructive structural features and the nuisance structural features identified from the plurality of reference structural features. The first subset includes the instructive structural features and excludes the nuisance structural features. A plurality of similarity values for reference structural features of the first subset is determined 916. The plurality of similarity values are determined based on the reference structural features of each reference case and the plurality of measured structural features. Specifically, the plurality similarity values are determined based on a frequency of occurrence of each reference structural feature of the reference case, within the plurality of measured structural features.

A plurality of similarity values for each reference case are determined 918 based on the plurality of similarity values for the reference structural features corresponding to the each of the plurality of reference cases. A plurality of similarity values for each of the fault identifier is obtained 920 based on the similarity values for the plurality of reference cases corresponding to each fault identifier. At least one fault identifier is determined 922 based on the plurality of similarity values corresponding to the plurality of fault identifiers.

The fault identifier system 100 shown in FIG. 1 may be used to diagnose faults in machines 102 using the fault identifiers and/or structural features representative of operation of the machines 102, and the reference fault identifiers and/or reference structural features associated with various reference cases. For example, the fault identifier system 100 can compare the fault identifiers from the data acquisition module with the reference fault identifiers of several different reference cases and, based on similarities or differences between the fault identifiers and the reference fault identifiers, identify one or more of the reference cases as being indicative of or similar to actual operation of the machine 102. The identified reference case or cases may then be examined to determine which reference structural features are included in or otherwise associated with the identified reference case or cases. These reference structural features may then be used to determine a likely or probable problem or fault with the machine. Different ones of these problems or faults (also referred to as structural features) can be associated with different repair recommendations (also referred to as Rx's or remedial recommendations) that can be applied to the machine 102 to fix the machine 102 so that the machine 102 no longer has the likely or probable problem. Optionally, the reference fault identifiers may be associated with or included in the repair recommendations such that, depending on how closely fault identifiers of an operating machine 102 match or otherwise correspond to the reference fault identifiers, one or more repair recommendations may be selected for repairing the machine 102.

In order to identify repair recommendations, the training module 108 of the system 100 can construct maps that define the reference cases (also referred to as “gold” cases) that can be used by the execution module 110 to infer what, if any, problems are occurring on the machine 102. These maps can be lists, tables, pointers, databases, or other memory structures, that associate different types of information with each other. For example, a first map can associate different reference case identifier (e.g., codes or other character strings used to identify the reference cases from each other) with one or more repair recommendation identifiers (e.g., a code or other character string used to identify the repair recommendations from each other). A second map can associate different individual reference case identifiers with one or more reference structural features (e.g., faults) that previously were identified as causing the problems previously identified for the machine when the reference structural features were identified. Optionally, the second map (or another map) may associate the reference cases with different sets of fault identifiers. One or more additional maps may be created.

In operation, the execution module 110 receives an actual case of structural features and/or fault identifiers for a machine 102 (which may be a different machine than the one or more machines used to create the maps described above). For example, the data acquisition module 106 may receive sensory data from the sensing unit 104 of the machine 102. This sensory data can represent the structural features (e.g., faults) of the machine 102, and may include fault identifiers representative of the structural features. Optionally, the data acquisition module 106 may receive the sensory data and determine the structural features and/or fault identifiers from the sensory data. The fault identifiers that are representative of the structural features determined from the sensory data of a machine 102 being examined may be referred to as actual fault identifiers.

The execution module 110 compares the actual fault identifiers of the case of the machine being examined with the reference fault identifiers associated with the different reference cases. Based on similarities and/or differences between the actual fault identifiers and the reference fault identifiers, the execution module 110 can determine which, if any, of the reference cases match the actual case (or more closely match the actual case than one or more other reference cases). For example, if fewer than a designated threshold (e.g., a designated percentage or fraction) of the actual fault identifiers are the same as the reference fault identifiers in a reference case, then that reference case is identified as a non-matching reference case, and may be excluded or otherwise ignored. The reference cases having reference fault identifiers that match the actual fault identifiers by more than this designated threshold are identified as reference cases of interest. The designated threshold may be 0.15 in one embodiment, but alternatively may be a larger or smaller number.

The execution module 110 then can map the reference cases of interest to associated repair recommendations. For example, the execution module 110 can use the first map described above to determine which repair recommendations correspond to the different reference cases of interest. The execution module 110 optionally may discard one or more reference cases of interest if the associated repair recommendations are incompatible with the machine 102 being examined. For example, if a reference case of interest has a repair recommendation that involves repairing equipment that is not included in the machine 102 being examined, then that reference case may be discarded or otherwise ignored.

For the remaining reference cases of interest, the execution module 110 can compare the similarities and/or differences between the reference fault identifiers and the actual fault identifiers in order to determine which repair recommendations to provide to an operator of the system 100. The execution module 110 can identify which of the reference cases have more reference fault identifiers that match or otherwise correspond to the actual fault identifiers of an actual case more than one or more other reference cases. The execution module 110 can select one or more of these reference cases (e.g., the top three or another number) and then output the repair recommendations of the selected reference case or cases to the operator.

In one embodiment, instead of using all fault identifiers (e.g., actual and/or reference) to determine similarities between the actual case and the reference cases, the system 100 may identify those fault identifiers that are instructive of the actual fault of the machine 102. For example, some fault identifiers may be less representative or emblematic of a problem with the machine 102 than other fault identifiers. The fault identifiers that are more representative of a fault in a machine 102 than one or more other fault identifiers can be referred to as instructive fault identifiers. As one example, instructive fault identifiers may be those fault identifiers that are not nuisance fault identifiers, such as those fault identifiers in the nuisance cases described above. For example, during examination of the machine 102, several different fault identifiers may be identified. Some of these fault identifiers may indicate a fault with the machine 102 that can be fixed or otherwise remediated (e.g., the impact of the fault may be lessened) by repairing the machine 102 according to a repair recommendation (e.g., a series of one or more tasks that repairs and/or replaces one or more components of the machine 102). Others of the fault identifiers may not indicate this fault, or may indicate another fault that is not fixed or otherwise remediated by the same repair recommendation (e.g., another repair recommendation may be more appropriate). These other fault identifiers may be referred to as nuisance fault identifiers.

In order to distinguish the instructive fault identifiers from other fault identifiers, the training module 108 can examine a coverage rate of the fault identifiers in a data set including several cases (e.g., reference cases). The coverage rate can represent a frequency or rate at which one or more fault identifiers occur in the cases. Those fault identifiers that appear in at least a designated threshold of the cases can be identified by the training module 108 as nuisance fault identifiers. In one example, this threshold may be 0.6% or another number, such that those fault identifiers appearing in at least 0.6% (or another number) of the cases are nuisance fault identifiers. The remaining fault identifiers (e.g., the non-nuisance fault identifiers in the data set) can then be examined against one or more criteria to determine if the identifiers are instructive fault identifiers. For example, if at least a designated threshold of the occurrences of a particular fault identifier support the repair recommendation of the reference cases in which the fault identifier appears (e.g., at least 40% or another number), then the fault identifier can be identified as an instructive fault identifier. A fault identifier may support the repair recommendation when the fault identifier identifies a structural feature (e.g., fault) that is repaired by the repair recommendation and/or that causes the fault to be fixed by the repair recommendation. Additionally or alternatively, a determination may be made as to whether a particular fault identifier appears more frequently in reference cases associated with the same repair recommendation than in reference cases associated with other repair recommendations. If so, then the fault identifier can be identified as an instructive fault identifier. The training module 108 can use a one-sided Fisher's exact test to identify such instructive fault identifiers, or may use another type of test or examination to identify the instructive fault identifiers. As one example, the training module 108 can calculate statistical significance parameters for the fault identifiers (e.g., as described above) and, depending on the values of the parameters, identify one or more of the fault identifiers as instructive fault identifiers. For example, the fault identifiers having larger statistical significance parameters than one or more other fault identifiers and/or greater than a threshold parameter may be instructive fault identifiers.

The instructive fault identifiers may then be compared to the actual fault identifiers of actual cases in order to determine which repair recommendations to provide to an operator of the system 100, as described above. For example, instead of comparing all fault identifiers in an actual case of fault identifiers to the reference fault identifiers, the execution module 110 may compare those actual fault identifiers that are instructive fault identifiers to the reference fault identifiers.

The training module 108 can repeatedly examine the reference cases over time to adjust which fault identifiers are instructive fault identifiers. The training module 108 can learn over time to improve the identification of instructive fault identifiers. In one aspect, the training module 108 can adapt to new technologies and/or changes to the machine 102. For example, with respect to a locomotive that has been modified to operate according to stricter emission standards, the training module 108 can adapt from previously identified instructive fault identifiers and learn to identify new and/or different instructive fault identifiers for the locomotive after the locomotive has been modified. This learning process can reduce the number of falsely identified problems with the machine 102 relative to the system 100 using the previously identified instructive fault identifiers to diagnose the machine 102.

In one aspect, this learning process includes building a map between nuisance cases of a machine 102 and repair recommendations for the machine 102. This map can subsequently be used to map actual fault identifiers to repair recommendations. During a training phase of the system 100 (e.g., while the training module 108 is determining which fault identifiers are instructive fault identifiers), the training module 108 can examine the fault identifiers of the nuisance cases that are considered as having relevant information for the improvement of the system 100. For example, an operator may select or otherwise identify those nuisance cases that may not have instructive fault identifiers (e.g., if the nuisance case is an actual nuisance case formed from fault identifiers that are not indicative of an actual fault of the machine 102). The training module 108 can examine the fault identifiers of the nuisance cases (as described above) and output no repair recommendations if the nuisance cases have relatively few or no instructive fault identifiers. Alternatively, the training module 108 may identify one or more repair recommendations from examination of the nuisance cases. The training module 108 can then examine the fault identifiers in the nuisance cases used to generate the repair recommendations to find out which fault identifiers, which are currently deemed as instructive, is the cause or potential cause for increased nuisance fault identifiers. In one aspect, a Fisher exact test can be used to examine these fault identifiers. As one example, the training module 108 can calculate statistical significance parameters for the nuisance fault identifiers (e.g., as described above) and, depending on the values of the parameters, identify one or more of the fault identifiers as the cause for the increased nuisance fault identifiers. For example, the fault identifiers having larger statistical significance parameters than one or more other fault identifiers and/or greater than a threshold parameter may be the cause of the increase in nuisance fault identifiers. Optionally, another test may be used. In one embodiment, the system 100 may iteratively examine the nuisance cases (e.g., repeat the process described herein) until there is no change for the selected instructive fault identifiers between at least a designated number of iterations (e.g., two or another number) or a designated number of iterations is reached (which may be set by the operator).

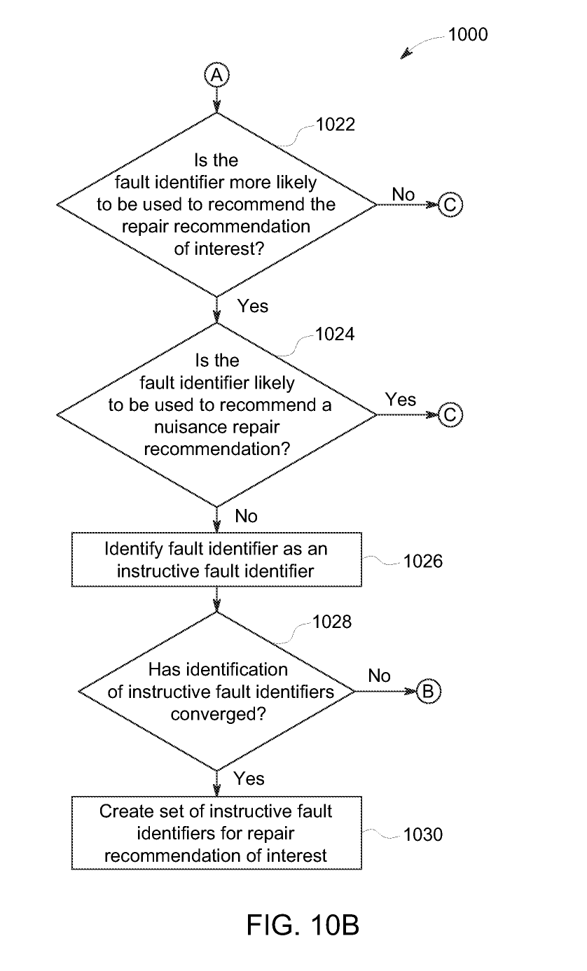

FIGS. 10A and 10B include a flow chart illustrating a method 1000 of identifying instructive fault identifiers according to an embodiment of the subject matter described herein. The method 1000 may be used to identify nuisance fault identifiers, which can include those fault identifiers that may not be helpful in identifying a particular repair recommendation. Different nuisance fault identifiers may be determined for different repair recommendations. For example, a fault identifier may not be helpful in identifying one repair recommendation, but may be helpful in identifying another repair recommendation for the same machine 102.

At 1002 (shown in FIG. 10A), a set of fault identifiers is obtained. These fault identifiers may be the fault identifiers included in one or more nuisance cases. Optionally, the fault identifiers may be obtained from one or more other cases or sets of data. The set of fault identifiers may be referred to as a training set of fault identifiers. The training module 108 or another component of the system 100 can obtain the set, such as from the database 112.

At 1004 (shown in FIG. 10A), a frequency of occurrence for one or more of the fault identifiers is determined. The occurrence frequency can represent how often a fault identifier appears in the data set. For example, the occurrence frequency can be a percentage, fraction, or the like, of times that a particular fault identifier occurs among the fault identifiers in the data set (e.g., among several different cases of fault identifiers associated with the same or different machines 102, which may be obtained at the same or different times). The training module 108 may calculate the occurrence frequency for one or more, or all, of the fault identifiers. Optionally, the training module 108 can calculate the occurrence frequency for only those fault identifiers selected by the operator or another component of the system 100.

At 1006 (shown in FIG. 10A), a determination is made as to whether the occurrence frequency for one or more of the fault identifiers exceeds an occurrence threshold (8). The occurrence threshold (δ) can be used to identify which of the fault identifiers in the set are potentially nuisance fault identifiers. The occurrence frequency for a fault identifier can be compared to this occurrence threshold (δ) and, if the occurrence frequency of the fault identifier exceeds the occurrence threshold (δ), then the fault identifier is identified as a nuisance fault identifier.

The occurrence threshold (δ) can represent a number of the reference cases associated with the reference fault identifiers such that, if the occurrence frequency for a fault identifier exceeds the occurrence threshold (δ), then that fault identifier may occur too frequently among the different reference cases to be helpful in identifying a repair recommendation. For example, because the fault identifier occurs more frequently than the occurrence threshold (δ) in the data set, the fault identifier may occur too often to be indicative of particular faults of the machine 102 or useful in identifying a repair recommendation to resolve faults of the machine 102. In one embodiment, the occurrence threshold (δ) has a value of six percent, but optionally may have a larger or smaller value. The value of the occurrence threshold (δ) can be altered or modified based on empirical experience or domain knowledge of operators of the system 100.

If the occurrence frequency for a fault identifier exceeds the occurrence threshold (δ), then the fault identifier may occur too often to be significantly useful in identifying appropriate repair recommendations for the machine 102. As a result, flow of the method 1000 may proceed from 1006 to 1008 (shown in FIG. 10A). On the other hand, if the occurrence frequency for the fault identifier is no greater than the occurrence threshold (8), then the fault identifier may occur infrequently enough to be useful in identifying appropriate repair recommendations for the machine 102. As a result, flow of the method 100 can proceed from 1006 to 1010 (shown in FIG. 10A).

At 1008 (shown in FIG. 10A), the fault identifier is identified as a nuisance fault identifier. The relatively low frequency of occurrence of the fault identifier (as determined at 1006) results in the fault identifier being identified or otherwise labeled as a nuisance fault identifier.

In one embodiment, after the nuisance fault identifiers are determined, the remaining fault identifiers are examined to determine which fault identifiers are indicative of one or more different repair recommendations in the reference cases. As described above, different repair recommendations may be mapped to different reference cases (e.g., using the first map described above). Additionally, different structural features and/or fault identifiers may be mapped to different reference cases (e.g., using the second map described above). For a repair recommendation, the fault identifiers that are mapped to the reference cases, which are mapped to the repair recommendation, can be examined to determine how often the fault identifiers are mapped (e.g., associated with) a particular repair recommendation. This repair recommendation may be referred to as a repair recommendation of interest or a selected repair recommendation.

At 1010 (shown in FIG. 10A), a coverage index of one or more of the fault identifiers is determined. The coverage index can be calculated for those fault identifiers that are not nuisance fault identifiers. The coverage index can represent how many of the reference cases associated with (e.g., mapped to) the repair recommendation of interest have a common fault identifier. For example, a repair recommendation identified by a code MT482 may be mapped to several hundred different reference cases. The number of these reference cases to which a first fault identifier is mapped or otherwise associated may represent a first coverage index for the first fault identifier and the number of these reference cases to which a second fault identifier is mapped or otherwise associated may represent a second coverage index for the second fault identifier. Optionally, the coverage index may represent a percentage of the reference cases that include the fault identifier and that are mapped to the same repair recommendation of interest.

At 1012 (shown in FIG. 10A), a determination is made as to whether a fault identifier occurs too infrequently for the selected repair recommendation. The coverage index for a fault identifier may be compared to one or more coverage thresholds and, based on this comparison, the fault identifier may be removed from consideration as being an instructive fault identifier. As one example, the coverage threshold may have a value of four (e.g., four reference cases) such that the fault identifiers that appear in three or fewer reference cases mapped to a common repair recommendation may occur too infrequently to be instructive fault identifiers. Fault identifiers that appear in four or more reference cases mapped to the same repair recommendation may occur frequently enough to be instructive fault identifiers. As another example, the coverage threshold may have a value of ten percent such that the fault identifiers appearing in less than ten percent of the reference cases mapped to a common repair recommendation may occur too infrequently to be instructive fault identifiers, while the fault identifiers appearing in at least ten percent of the reference cases mapped to the repair recommendations may occur frequently enough to be instructive fault identifiers. Optionally, the coverage threshold may have another value. For example, different coverage thresholds may be used for different types of machines 102, different copies of the same type of machine 102, or the like.

If the fault identifier occurs too infrequently (e.g., the coverage index for the fault identifier does not meet or exceed the coverage threshold), then the fault identifier may not be an instructive fault identifier for the repair recommendation of interest and flow of the method 1000 can proceed to 1008, where the fault identifier is identified as a nuisance fault identifier for the repair recommendation of interest. The fault identifier may still be an instructive fault identifier for one or more other repair recommendations, however. If the fault identifier occurs more frequently (e.g., the coverage index meets or exceeds the coverage threshold), then the fault identifier may be an instructive fault identifier and flow of the method 1000 can proceed to 1014 (shown in FIG. 10A).

At 1014, a confusion probability (p_{c}) is determined for one or more of the fault identifiers. In one aspect, confusion probabilities (p_{c}) are calculated for the fault identifiers that have not yet been discarded as nuisance fault identifiers. The confusion probability (p_{c}) for a fault identifier can represent a likelihood, percentage, or the like, that the fault identifier is not representative of a fault that is fixed or remediated with a particular or selected repair recommendation. Optionally, the confusion probability (p_{c}) can represent a likelihood, percentage, or the like, that the fault identifier is representative of other faults that are not fixed or remediated with the particular or selected repair recommendation, or that is fixed or remediated with other repair recommendations.

In one example, the confusion probability (p_{c}) is calculated using the following relationship:

$${p}_{c} = 1 - \frac{A}{A + B}$$

where p_{c} represents the confusion probability, A represents a number of reference cases that include the fault identifier for which the confusion probability is being calculated and that are mapped to a particular or selected repair recommendation (e.g., such as can be calculated using the top left quadrant of the table 700 shown in FIG. 7), and B represents a number of reference cases that include the same fault identifier but that are mapped to another, different repair recommendation (e.g., such as is can be calculated using the top right quadrant of the table 700).

The resulting confusion probability for a fault identifier can represent the likelihood that the fault identifier is not associated with the repair recommendation or the probability that the fault identifier is associated with other repair recommendations. As the value of the confusion probability decreases, the more probable it is that the fault identifier is an indicator of the particular or selected repair recommendation.

At 1018 (shown in FIG. 10A), the confusion probability for one or more of the fault identifiers is examined to determine if the confusion probability indicates that the fault identifier or identifiers are instructive fault identifiers. In one embodiment, the confusion probability for a fault identifier is compared to a confusion threshold (μ). If the confusion probability is less than the confusion threshold, then the confusion probability may indicate that the fault identifier is an instructive fault identifier for the repair recommendation. For example, the relatively low probability that the fault identifier is indicative of a fault that can be fixed by another repair recommendation may indicate that the fault identifier is indicative of another fault that can be fixed by the particular or selected repair recommendation. As a result, flow of the method 1000 can proceed to 1020 (shown in FIG. 10A). At 1020, the fault identifier is identified or otherwise labeled as an instructive fault identifier. The fault identifier may be used to diagnose machines 102 in order to determine repair recommendations that repair or otherwise remediate one or more faults with the machines 102, as described above.

On the other hand, if the confusion probability is as large as or larger than the confusion threshold, then the confusion probability may indicate that the fault identifier is not an instructive fault identifier for the repair recommendation. As a result, flow of the method 1000 can proceed to 1022 (shown in FIG. 10A). The value of the confusion threshold may vary, but in one embodiment, the confusion threshold may have a value of 0.3 or thirty percent. Consequently, a fault identifier may be instructive if seventy percent of the occurrences of the fault identifier support the repair recommendation. Alternatively, another value of the confusion threshold may be used.

In one embodiment, even if the confusion probability for a fault identifier does not indicate that the fault identifier is an instructive fault identifier, the fault identifier may still be an instructive fault identifier if the fault identifier is more likely to indicate the repair recommendation of interest instead of one or more other repair recommendations.

At 1022, a determination is made as to whether the fault identifier is more likely to be mapped to (e.g., used by the system 100 to recommend) the repair recommendation of interest than one or more other repair recommendations, such as a designated number of repair recommendations. For example, a calculation or estimation may be performed that determines if the fault identifier is more likely to appear in (e.g., be associated with) the repair recommendation of interest than all other repair recommendations, than a designated set of the other repair recommendations (e.g., the other ten or other number of most recently used repair recommendations), than another number of the repair recommendations, or the like.

In one embodiment, a Fisher exact test can used to determine if the fault identifier is more likely to be associated with (e.g., mapped to) the repair recommendation of interest than other repair recommendations. As one example, the training module 108 can calculate statistical significance parameters for the fault identifiers (e.g., as described above) and, depending on the values of the parameters, identify one or more of the fault identifiers as being associated with a repair recommendation. For example, the fault identifiers having larger statistical significance parameters for a repair recommendation than one or more other fault identifiers and/or greater than a threshold parameter may be instructive fault identifiers for that repair recommendation.

Optionally, another test or examination can be used. For example, a historical log of previously identified fault identifiers and repair recommendations can be examined to determine if a particular fault identifier is more likely to be used by the execution module 110 to recommend the repair recommendation of interest than one or more other repair recommendations. If the fault identifier is more likely to be used by the system 100 to recommend the repair recommendation of interest to the operator of the system 100 than one or more other repair recommendations (e.g., or more than a designated set of the other repair recommendations), then flow of the method 1000 can proceed to 1024 (shown in FIG. 10A). But, if the fault identifier is more likely to be used by the system 100 to recommend another repair recommendation or at least a designated number of repair recommendations instead of the repair recommendation of interest, then flow of the method 1000 can return to proceed to 1008, where the fault identifier is identified as a nuisance fault identifier for the repair recommendation of interest. The fault identifier may still be an instructive fault identifier for one or more other repair recommendations, however.

At 1024 (shown in FIG. 10A), a determination is made as to whether the fault identifier being examined is likely to be used to recommend a nuisance repair recommendation. As one example, the system 100 may receive, as input, the data of one or more of the nuisance cases. The system 100 can examine the sensory data, structural features, fault identifiers, or the like, of the nuisance cases and then output one or more repair recommendations based on the examination of this data, as described above. These repair recommendations may be referred to as “nuisance repair recommendations.”

The fault identifiers in the data that is examined to identify the nuisance repair recommendations may be identified as nuisance fault identifiers. If a nuisance repair recommendation is associated with at least a designated number of the nuisance cases (e.g., when examined by the system 100), the fault identifiers associated with these nuisance cases may be examined to determine which of the fault identifiers result in the nuisance repair recommendation being recommended (e.g., by the system 100). If the fault identifier being examined is one of the fault identifiers used to recommend a nuisance repair recommendation, then flow of the method 1000 can proceed to 1008, where the fault identifier is identified as a nuisance fault identifier. Otherwise, flow of the method 1000 can proceed to 1026 (shown in FIG. 10B). For example, if the fault identifier being examined is not one of the fault identifiers used to recommend a nuisance repair recommendation, then the method 1000 can proceed to 1026.

At 1026, the fault identifier being examined is identified or otherwise labeled as an instructive fault identifier. The fault identifier may be used to diagnose machines 102 in order to determine repair recommendations that repair or otherwise remediate one or more faults with the machines 102, as described above.

At 1028 (shown in FIG. 10B), a determination is made as to whether identification of instructive fault identifiers for one or more of the repair recommendations has converged. The method 1000 may be repeated one or more times for at least one of the repair recommendations to identify those fault identifiers that are instructive versus those that are nuisances. For example, during a first performance of the method 1000, several nuisance fault identifiers for many repair recommendations can be identified (e.g., at 1002, 1004, 1006, and/or 1008 shown in FIG. 10A) and then instructive and/or nuisance fault identifiers can be identified for a repair recommendation of interest (e.g., at 1008, 1010, 1012, 1014, 1018, 1020, 1022, 1024, and/or 1026). The method 1000 optionally may be repeated with the previously identified instructive and/or nuisance fault identifiers in order to determine if any additional, new, and/or different instructive fault identifiers and/or nuisance fault identifiers are identified. If the set of instructive and/or nuisance fault identifiers that is identified from a current performance of all or part of the method 1000 is the same or similar to a previously identified set, then identification of the instructive fault identifiers has converged. Previously and currently identified sets of the fault identifiers may be similar when the sets match by at least a designated threshold (e.g., 50%, 60%, 75%, 80%, 90%, 95%, 97.5%, or another amount). Optionally, identification of the fault identifiers may have converged when the identification of the fault identifiers is repeated a designated number of times (e.g., three, four, five, or the like).

If identification of the fault identifiers has not converged, then flow of the method 1000 may return to another operation to continue with the identification of instructive and/or nuisance fault identifiers. For example, the method 1000 may return to 1010 (shown in FIG. 10A) or another operation. On the other hand, if identification of the fault identifiers has not yet converged, then the method 1000 can proceed to 1030.

At 1030, the instructive fault identifiers that have been identified during one or more operations of (all or part of) the method 1000 can be associated with the repair recommendation of interest. For example, the instructive fault identifiers (and the structural features represented by the fault identifiers) may be used for comparing to sensory data of actual cases of the machine 102 in order to determine when to recommend the repair recommendation of interest to the operator of the system 100 or another operator. All or part of the method 1000 may be repeated in order to identify sets of instructive fault identifiers for one or more other repair recommendations.

Example embodiments of the case-based reasoning technique disclosed herein enables determination of at least one fault identifier among a plurality of fault identifiers associated with a plurality of reference cases representative of an operating condition of the machine. Determination of instructive structural features from the plurality of reference structural features for computing the plurality of similarity values facilitates reduction of false alarms while diagnosing an operating condition of the machine. It is to be understood that not necessarily all such objects or advantages described above may be achieved in accordance with any particular embodiment. Thus, for example, those of ordinary skill in the art can recognize that the systems and techniques described herein may be embodied or carried out in a manner that achieves or improves one advantage or group of advantages as taught herein without necessarily achieving other objects or advantages as may be taught or suggested herein.

In one embodiment, a method of identifying instructive fault identifiers to assist in the diagnosis of machine faults includes obtaining potentially instructive fault identifiers indicative of potential faults of one or more machines. The potentially instructive fault identifiers can be compared to reference fault identifiers included in different reference cases that are associated with repair recommendations for the one or more machines. The method also can include determining frequencies of occurrences of the potentially instructive fault identifiers among the reference cases and determining coverage indices of the potentially instructive fault identifiers. The coverage indices indicate how many of the reference cases associated with a selected repair recommendation of the repair recommendations include one or more of the potentially instructive fault identifiers. The method also can include determining one or more confusion probabilities that the one or more of the potentially instructive fault identifiers is indicative of a repair recommendation other than the selected repair recommendation and identifying at least one of the potentially instructive fault identifiers as instructive fault identifiers for the selected repair recommendation based on one or more of the frequencies of occurrences, the coverage indices, and/or the one or more confusion probabilities.

In one aspect, the method also includes obtaining sensory data from at least one of the machines, examining the sensory data to identify one or more potential fault identifiers, and comparing the one or more potential fault identifiers with the instructive fault identifiers for the selected repair recommendation in order to determine whether to recommend that the selected repair recommendation be employed to at least one of fix or remediate one or more faults of the at least one of the machines.

In one aspect, the method also includes determining if identification of the instructive fault identifiers for the selected repair recommendation has converged and repeating one or more of: determining the coverage indices or determining the confusion probabilities responsive to determining that the identification of the instructive fault identifiers has not converged.

In one aspect, the method also includes determining which of the potentially instructive fault identifiers are more likely to be indicative of the selected repair recommendation than one or more of a designated set of other repair recommendations or a nuisance repair recommendation.

In one aspect, the frequencies of occurrences represent how many of the reference cases are associated with reference fault identifiers that match the potentially instructive fault identifiers.

In one aspect, the method also includes comparing the frequencies of occurrences of the potentially instructive fault identifiers to an occurrence threshold and identifying the potentially instructive fault identifiers having the frequencies of occurrences that are less than the occurrence threshold as the instructive fault identifiers for the selected repair recommendation.

In one aspect, the method also includes comparing the coverage indices of the potentially instructive fault identifiers to one or more coverage thresholds and identifying the potentially instructive fault identifiers having the coverage indices that are smaller than the one or more coverage thresholds as the instructive fault identifiers for the selected repair recommendation.

In another embodiment, a system (e.g., a fault identifier system) includes a training module configured to obtain potentially instructive fault identifiers indicative of potential faults of one or more machines. The potentially instructive fault identifiers can be compared to reference fault identifiers included in different reference cases that are associated with repair recommendations for the one or more machines. The training module also can be configured to determine frequencies of occurrences of the potentially instructive fault identifiers among the reference cases and to determine coverage indices of the potentially instructive fault identifiers. The coverage indices can indicate how many of the reference cases associated with a selected repair recommendation of the repair recommendations include one or more of the potentially instructive fault identifiers. The training module also can be configured to determine one or more confusion probabilities that the one or more of the potentially instructive fault identifiers is indicative of a repair recommendation other than the selected repair recommendation and to identify at least one of the potentially instructive fault identifiers as instructive fault identifiers for the selected repair recommendation based on one or more of the frequencies of occurrences, the coverage indices, or the one or more confusion probabilities.

In one aspect, the training module includes at least one computer processor.

In one aspect, the system also includes a data acquisition module and an execution module. The data acquisition module and/or the execution module can include one or more computer processors. The data acquisition module can be configured to obtain sensory data from at least one of the machines and to examine the sensory data to identify one or more potential fault identifiers. The execution module can be configured to compare the one or more potential fault identifiers with the instructive fault identifiers for the selected repair recommendation in order to determine whether to recommend that the selected repair recommendation be employed to at least one of fix or remediate one or more faults of the at least one of the machines.

In one aspect, the training module can be configured to determine if identification of the instructive fault identifiers for the selected repair recommendation has converged and, responsive to determining that the identification of the instructive fault identifiers has not converged, the training module is configured to repeat one or more of: determine the coverage indices or determine the confusion probabilities.

In one aspect, the training module also is configured to determine which of the potentially instructive fault identifiers are more likely to be indicative of the selected repair recommendation than one or more of a designated set of other repair recommendations or a nuisance repair recommendation.

In one aspect, the frequencies of occurrences represent how many of the reference cases are associated with reference fault identifiers that match the potentially instructive fault identifiers.

In one aspect, the training module is configured to compare the frequencies of occurrences of the potentially instructive fault identifiers to an occurrence threshold and to identify the potentially instructive fault identifiers having the frequencies of occurrences that are less than the occurrence threshold as the instructive fault identifiers for the selected repair recommendation.

In one aspect, the training module is configured to compare the coverage indices of the potentially instructive fault identifiers to one or more coverage thresholds and to identify the potentially instructive fault identifiers having the coverage indices that are smaller than the one or more coverage thresholds as the instructive fault identifiers for the selected repair recommendation.

In another embodiment, another method (e.g., for diagnosing machine faults) includes examining fault identifiers associated with different reference cases associated with different repair recommendations for one or more machines. The fault identifiers are representative of potential faults of the one or more machines, and can be examined to differentiate instructive fault identifiers from nuisance fault identifiers. The method also can include identifying actual fault identifiers determined from sensory data obtained from an operating machine and determining one or more repair recommendations for the operating machine by comparing the actual fault identifiers with the instructive fault identifiers.

In one aspect, examining the fault identifiers includes determining frequencies of occurrences of the fault identifiers among the reference cases.

In one aspect, examining the fault identifiers includes determining coverage indices of the fault identifiers. The coverage indices can indicate how many of the reference cases associated with a selected repair recommendation of the repair recommendations include one or more of the potentially instructive fault identifiers.

In one aspect, examining the fault identifiers can include determining one or more confusion probabilities that the one or more of the fault identifiers is indicative of one of the repair recommendations other than a selected repair recommendation of the repair recommendations.

In one aspect, the method also can include determining if identification of the instructive fault identifiers for a selected repair recommendation has converged and examining the fault identifiers one or more additional times responsive to determining that the identification of the instructive fault identifiers has not converged.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the technology has been described in detail in connection with only a limited number of embodiments, it should be readily understood that the invention are not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the inventions may include only some of the described embodiments. Accordingly, the inventions are not to be seen as limited by the foregoing description, but are only limited by the scope of the appended claims. What is claimed as new and desired to be protected by Letters Patent of the United States is:

1. A method comprising:
obtaining potentially instructive fault identifiers indicative of potential faults of one or more machines, the potentially instructive fault identifiers are compared to reference fault identifiers included in different reference cases that are associated with repair recommendations for the one or more machines;
determining frequencies of occurrences of the potentially instructive fault identifiers among the reference cases;
determining coverage indices of the potentially instructive fault identifiers, the coverage indices indicating how many of the reference cases associated with a selected repair recommendation of the repair recommendations include one or more of the potentially instructive fault identifiers;
determining one or more confusion probabilities that the one or more of the potentially instructive fault identifiers is indicative of a repair recommendation other than the selected repair recommendation; and
identifying at least one of the potentially instructive fault identifiers as instructive fault identifiers for the selected repair recommendation based on one or more of the frequencies of occurrences, the coverage indices, or the one or more confusion probabilities.

2. The method of claim 1, further comprising obtaining sensory data from at least one of the machines, examining the sensory data to identify one or more potential fault identifiers, and comparing the one or more potential fault identifiers with the instructive fault identifiers for the selected repair recommendation in order to determine whether to recommend that the selected repair recommendation be employed to at least one of fix or remediate one or more faults of the at least one of the machines.

3. The method of claim 1, further comprising:
determining if identification of the instructive fault identifiers for the selected repair recommendation has converged; and
repeating one or more of: determining the coverage indices or determining the one or more confusion probabilities responsive to determining that the identification of the instructive fault identifiers has not converged.

4. The method of claim 1, further comprising determining which of the potentially instructive fault identifiers are more likely to be indicative of the selected repair recommendation than one or more of a designated set of other repair recommendations or a nuisance repair recommendation.

5. The method of claim 1, wherein the frequencies of occurrences represent how many of the reference cases are associated with reference fault identifiers that match the potentially instructive fault identifiers.

6. The method of claim 1, further comprising comparing the frequencies of occurrences of the potentially instructive fault identifiers to an occurrence threshold and identifying the potentially instructive fault identifiers having the frequencies of occurrences that are less than the occurrence threshold as the instructive fault identifiers for the selected repair recommendation.

7. The method of claim 1, further comprising comparing the coverage indices of the potentially instructive fault identifiers to one or more coverage thresholds and identifying the potentially instructive fault identifiers having the coverage indices that are smaller than the one or more coverage thresholds as the instructive fault identifiers for the selected repair recommendation.

8. A system comprising:
a training module configured to obtain potentially instructive fault identifiers indicative of potential faults of one or more machines, the potentially instructive fault identifiers compared to reference fault identifiers included in different reference cases that are associated with repair recommendations for the one or more machines, the training module also configured to determine frequencies of occurrences of the potentially instructive fault identifiers among the reference cases and to determine coverage indices of the potentially instructive fault identifiers, wherein the coverage indices indicate how many of the reference cases associated with a selected repair recommendation of the repair recommendations include one or more of the potentially instructive fault identifiers, and wherein the training module is configured to determine one or more confusion probabilities that the one or more of the potentially instructive fault identifiers is indicative of a repair recommendation other than the selected repair recommendation and to identify at least one of the potentially instructive fault identifiers as instructive fault identifiers for the selected repair recommendation based on one or more of the frequencies of occurrences, the coverage indices, or the one or more confusion probabilities.

9. The system of claim 8, wherein the training module includes at least one computer processor.

10. The system of claim 8, further comprising:
a data acquisition module configured to obtain sensory data from at least one of the machines and to examine the sensory data to identify one or more potential fault identifiers; and
an execution module configured to compare the one or more potential fault identifiers with the instructive fault identifiers for the selected repair recommendation in order to determine whether to recommend that the selected repair recommendation be employed to at least one of fix or remediate one or more faults of the at least one of the machines.

11. The system of claim 8, wherein the training module is configured to determine if identification of the instructive fault identifiers for the selected repair recommendation has converged and, responsive to determining that the identification of the instructive fault identifiers has not converged, the training module is configured to repeat one or more of: determine the coverage indices or determine the confusion probabilities.

12. The system of claim 8, wherein the training module also is configured to determine which of the potentially instructive fault identifiers are more likely to be indicative of the selected repair recommendation than one or more of a designated set of other repair recommendations or a nuisance repair recommendation.

13. The system of claim 8, wherein the frequencies of occurrences represent how many of the reference cases are associated with reference fault identifiers that match the potentially instructive fault identifiers.

14. The system of claim 8, wherein the training module is configured to compare the frequencies of occurrences of the potentially instructive fault identifiers to an occurrence threshold and to identify the potentially instructive fault identifiers having the frequencies of occurrences that are less than the occurrence threshold as the instructive fault identifiers for the selected repair recommendation.

15. The system of claim 8, wherein the training module is configured to compare the coverage indices of the potentially instructive fault identifiers to one or more coverage thresholds and to identify the potentially instructive fault identifiers having the coverage indices that are smaller than the one or more coverage thresholds as the instructive fault identifiers for the selected repair recommendation.

16. A method comprising:
examining fault identifiers associated with different reference cases associated with different repair recommendations for one or more machines, the fault identifiers representative of potential faults of the one or more machines, the fault identifiers examined to differentiate instructive fault identifiers from nuisance fault identifiers;
identifying actual fault identifiers determined from sensory data obtained from an operating machine; and
determining one or more repair recommendations for the operating machine by comparing the actual fault identifiers with the instructive fault identifiers.

17. The method of claim 16, wherein examining the fault identifiers includes determining frequencies of occurrences of the fault identifiers among the reference cases.

18. The method of claim 16, wherein examining the fault identifiers includes determining coverage indices of the fault identifiers, the coverage indices indicating how many of the reference cases associated with a selected repair recommendation of the repair recommendations include one or more of the potentially instructive fault identifiers.

19. The method of claim 16, wherein examining the fault identifiers includes determining one or more confusion probabilities that the one or more of the fault identifiers is indicative of one of the repair recommendations other than a selected repair recommendation of the repair recommendations.

20. The method of claim 16, further comprising:
determining if identification of the instructive fault identifiers for a selected repair recommendation of the repair recommendations has converged; and
examining the fault identifiers one or more additional times responsive to determining that the identification of the instructive fault identifiers has not converged.
